(19) United States
(12) Patent Application Publication
(10) Pub. No.: US 2013/0201308 A1
(43) Pub. Date: Aug. 8, 2013

(54) VISUAL BLIND-GUIDING METHOD AND INTELLIGENT BLIND-GUIDING DEVICE THEREOF

(71) Applicants: Yun Tan, Shenzhen (CN); Yiliang Ou, Shenzhen (CN); Ping Liu, Shenzhen (CN)

(72) Inventors: Yun Tan, Shenzhen (CN); Yiliang Ou, Shenzhen (CN); Ping Liu, Shenzhen (CN)

(21) Appl. No.: 13/634,247

(22) PCT Filed: Mar. 31, 2012
(86) PCT No.: PCT/CN2012/073364

§ 371 Date: Sep. 12, 2012

(30) Foreign Application Priority Data
Jun. 10, 2011 (CN) 201110155763.X

(51) Int. Cl. G09B 21/00

(52) U.S. Cl. CPC G09B 21/003
USPC 348/62

(57) ABSTRACT

A visual blind-guiding method is disclosed, which includes the following steps: (1) shooting a black-and-white image, and extracting profile information from the black-and-white image to reduce detail elements and refine the image, so as to obtain an object profile signal; (2) according to ergonomic features, converting the object profile signal into a serial signal, and conveying the serial signal to an image feeling instrument, where the image feeling instrument converts the serial signal into a mechanical tactile signal to emit feeler pin stimulation, an intermittent picture touch mode is used with respect to the speed of touch for vision, and an appropriate human-sensitive feeler pin array is adopted with respect to the quantity, so that the blind can really touch a shape of an object.

### CROSS-REFERENCE TO RELATED APPLICATIONS

This application is a national phase application of PCT/CN2012/073364, filed on Mar. 31, 2012. The contents of PCT/CN2012/073364 are all hereby incorporated by reference.

### BACKGROUND

1. Technical Field

The present application relates to a blind-guiding method and device, and more particularly to a visual blind-guiding method and an intelligent blind-guiding device thereof.

2. Related Art

As the society progresses, difficulties of the blind in living due to visual impairments becomes an issue of common concern of all mankind. Due to different causes of vision loss of the blind, a direct operation or re-built organ assistance has a very big technical risk and a use risk, and is a large job. Various blind-guiding products, mainly including a blind-guiding dog and electronic blind-guiding, appear in the market. The electronic blind-guiding is mainly a blind-guiding device mainly probing a barrier through ultrasound, for example, a blind-guiding stick, a blind-guiding cap, or a blind-guiding tube, capable of probing a position of a barrier or object. The blind-guiding products all can assist the blind in outdoor activities and play a part in blind-guiding when the blind walk. However, through the blind-guiding products, the blind cannot know a shape of an object or the barrier, and when avoiding the barrier, the blind must have the aid of the touch of the hand or stick knocking to obtain more feature information. For many years, technicians seek for a device capable of helping the blind to see the shape of the barrier and even the ambient environment. A blind-guiding device is proposed in a relevant material published at home in 2009. In the blind-guiding device, a color camera is adopted to collect an image, and the image is transferred to a worn tactile device, so that the blind can see the color image through touch. However, according to the development level of the existing science and technology and the specificity of the ergonomic features, it is difficult to implement the blind-guiding device.

First, it is mentioned in this method that, after the image is collected through the color camera with high definition, in order to enable the blind to touch the color image, a very complex image recognition technology must be used, so a lot of data access, calculation, and comparing processes are required to recognize target features of the image. At present, the image recognition is a leading technical issue, and robot image recognition is limited to recognition of specific targets, so a serious technical bottleneck exists when the robot image recognition technology is applied to systematic blind-guiding. Secondly, a high definition image is directly transferred to the tactile device, the definition of the tactile device depends on a size of the array of the tactile device, it is mentioned in the material that, the more feeler pins in the tactile array are, the more definite the image seen by the blind is. The image is a real-time image with a very high speed, but the human feeling lags seriously, and tactile nerves recognize object features mainly in a serial recognition manner, so that it is difficult for the recognition of the transferred image of the tactile device mentioned in the article to meet the requirement of tactile perception of the blind with respect to time, quantity and manner.

### SUMMARY

The technical problems to be solved by the present application are as follows. To overcome the disadvantages and shortage, a visual blind-guiding method and an intelligent blind-guiding device thereof are provided, really enabling the blind to recognize a shape of an object and effectively avoid a barrier.

The visual blind-guiding method of the present application adopts the following technical solutions.

The visual blind-guiding method includes:

(1) shooting a black-and-white image, and extracting profile information from the black-and-white image to reduce detail elements and refine the image, so as to obtain an object profile signal;

(2) according to ergonomic features, converting the object profile signal into a serial signal, conveying the serial signal to an image feeling instrument, where the image feeling instrument converts the serial signal into a mechanical tactile signal to emit feeler pin stimulation, an intermittent picture touch mode is used with respect to the speed of touch for vision, and an appropriate human body-sensitive feeler pin array is adopted with respect to the quantity, so that the blind really touch a shape of an object.

Since no requirement on definition and chromaticity is put on the black-and-white image obtained by the black-and-white camera, when the black-and-white image is refined, only the main profile information of the object is generated to reduce the detail element information of the object and is transmitted to the image feeling instrument in series. According to a research result of the ergonomics, the image feeling instrument outputs the mechanical tactile signal in series, where the intermittent picture touch mode rather than a continuous one is used with respect to the speed of touch for vision, the intermittent picture touch mode means that a picture is output at a certain interval, so as to really enable the blind to touch the shape of the object.

Preferably, the method further includes a step (3): probing position information of the object, and processing the position information to obtain and prompt a distance of the object and a safe avoiding direction. The probed position information of the object is processed to obtain and prompt the distance of the object and the safe avoiding direction, so that the blind can not only perceive the shape of the object but also know the distance of the object, thereby resulting in more effective blind-guiding.

Preferably, the feeler pin array is a rectangular array of mechanical vibration contacts.

The intelligent blind-guiding device of the present application adopts the following technical solutions.

The intelligent blind-guiding device includes a probing mechanism, a microprocessor controller, an image feeling instrument, and a prompting device. The probing mechanism includes a camera device and an ultrasonic probe. The microprocessor controller is respectively connected to the camera device, the ultrasonic probe, the image feeling instrument, and the prompting device. The camera device is used for collecting a black-and-white image of front scenery. The microprocessor controller performs extraction on the black-and-white image to obtain an object profile signal, converts the object profile signal into a serial signal, and outputs the serial signal to the image feeling instrument. The image feeling instrument converts the serial signal into a mechanical tactile signal to emit feeler pin stimulation. The ultrasonic probe is used for measuring position information of an ambient object. The microprocessor controller processes the position information of the object to obtain a distance of the object and a safe avoiding direction and transmits the distance of the object and the safe avoiding direction to the prompting device. The prompting device is used for prompting the distance of the object and the safe avoiding direction.

The image feeling instrument is adopted to generate mechanical tactile information to emit the feeler stimulation, and meanwhile the position of the object is prompted, thereby implementing safe and effective blind-guiding.

Preferably, the image feeling instrument includes a modulation driving circuit board, a feeler pin array and a support mechanism for mounting the modulation driving circuit board and the feeler pin array, the modulation driving circuit board is used for receiving, in series, the serial signal sent by the microprocessor controller and driving, in series, the feeler pin array to work, and the object profile signal corresponds to the feeler pin array in a point-to-point proportion.

Preferably, the feeler pin array is a rectangular array of mechanical vibration contacts formed by piezoelectric ceramic vibrators, and the support mechanism is tightly fit to a sensitive skin region of a human body.

Preferably, the microprocessor controller includes a keyboard, a power supply, and a circuit board; an ARM microprocessor, an input/output (I/O) interface, a voice module, a video signal receiving and decoding module, a Field Programmable Gate Array (FPGA) programmable controller, and an image feeling instrument interface module are disposed on the circuit board; the ARM microprocessor is connected to the I/O interface, the FPGA programmable controller, the image feeling instrument interface module, the voice module, the power supply, the keyboard, and vibration prompters; the FPGA programmable controller is connected to the video signal receiving and decoding module; the video signal receiving and decoding module is connected to the camera device; the voice module is externally connected to a voice prompter; the image feeling instrument interface module is externally connected to the image feeling instrument; and the I/O interface is externally connected to the ultrasonic probes.

Preferably, the microprocessor controller further includes a function changing-over switch, the function changing-over switch is connected to the ARM microprocessor and includes a training option and a normal option, the circuit board further includes a video training module, and the video training module is connected to the video signal receiving and decoding module. Through the disposed video training module in combination with certain comprehensive training, the capability of recognizing the shape of the object and avoiding the barrier can be improved, thereby gradually improving the touch for vision level and activity capability.

Preferably, the FPGA programmable controller is used for performing image conversion processing on an image collected by the video signal receiving and decoding module to obtain the object profile signal, wherein the image conversion processing includes image freezing, dynamic capturing, image zoom-in, image zoom-out, positive strengthening, or negative strengthening.

Preferably, the probing mechanism is a head mechanism, which includes an adjustable head band, a glass body, and a fixing mechanism; the glass body is connected to the fixing mechanism through the head band; four ultrasonic probes are provided and include front, rear, left, and right ultrasonic probes, and each ultrasonic probe includes a transmission probe and a receiving probe; a camera lens of the camera device and the front ultrasonic probe are mounted right in front of the glass body; the left ultrasonic probe and the right ultrasonic probe are respectively mounted at left and right sides of the glass body; the rear ultrasonic probe is mounted in the fixing mechanism; the prompting device includes front, rear, left, and right vibration prompters, respectively used for prompting the distance of the object and the safe avoiding direction according to the direction of the object probed by the front, rear, left, and right ultrasonic probes.

Through the technical solutions of the present application, the blind can not only effectively probe the surrounding barrier to avoid the surrounding barrier object, but also “see” the profile of the object in front of eyes, recognize the shape of the object, and furthermore, through continuous training and accumulation, know increasingly more objects gradually.

### BRIEF DESCRIPTION OF THE DRAWINGS

The present application will become more fully understood from the detailed description given herein below for illustration only, and thus are not limitative of the present application, and wherein:

FIG. 1 is a system diagram of an intelligent blind-guiding device of an embodiment of the present application;

FIG. 2 is a schematic three-dimensional view of an assembled intelligent blind-guiding device of the embodiment of the present application;

FIG. 3 is a schematic three-dimensional exploded view of a probing mechanism in FIG. 2;

FIG. 4 is a schematic three-dimensional exploded view of a microprocessor controller in FIG. 2;

FIG. 5 is a schematic three-dimensional exploded view of an image feeling instrument in FIG. 2.

### LIST OF REFERENCE NUMERALS

Probing mechanism 1: glass body 10, head band 18, fixing mechanism 19, camera lens 11, black-and-white CCD image sensor 12, image processing circuit 13, front ultrasonic probe 16, left ultrasonic probe 14, right ultrasonic probe 15, rear ultrasonic probe 17;

Cables 2, 4, 6;

Microprocessor controller 3: keyboard 31, power supply switch 32, function changing-over switch 33, buzzer 34, loudspeaker 35, power supply 36, circuit board 37 (ARM microprocessor 371, I/O interface 372, voice module 373, video signal receiving and decoding module 374, FPGA programmable controller 375, image feeling instrument interface module 376, video training module 377), power supply indicator lamp 38;

Image feeling instrument 5: modulation driving circuit board 52, feeler pin array 51, support mechanism 53;

Front vibration prompter 71, rear vibration prompter 72, left vibration prompter 73, right vibration prompter 74

### DETAILED DESCRIPTION

The present application is described in detail in the following with reference to the accompanying drawings and preferred specific embodiments.

In an embodiment, a visual blind-guiding method includes the following steps: (1) shooting a black-and-white image, and extracting profile information from the black-and-white image to reduce detail elements and refine the image, so as to obtain an object profile signal; (2) according to ergonomic features, conveying the object profile signal to an image feeling instrument in a serial manner, where the image feeling instrument converts the object profile signal into a mechanical tactile signal output in series, an intermittent picture touch mode is used with respect to the speed of touch for vision, and an appropriate human body-sensitive feeler pin array with respect to the quantity is adopted, so that the blind really touch a shape of an object.

Preferably, the method further includes the following step: (3) probing position information of the object, and processing the position information to obtain and prompt a distance of the object and a safe avoiding direction.

In an embodiment, an intelligent blind-guiding device includes a probing mechanism, a microprocessor controller, an image feeling instrument, and a prompting device. The probing mechanism includes a camera device and an ultrasonic probe. The microprocessor controller is respectively connected to the camera device, the ultrasonic probe, the image feeling instrument, and the prompting device. The camera device is used for collecting a black-and-white image of front scenery. The microprocessor controller performs extraction on the black-and-white image to obtain an object profile signal, converts the object profile signal into a serial signal, and outputs the serial signal to the image feeling instrument. The image feeling instrument converts the serial signal into a mechanical tactile signal to emit feeler pin stimulation. The ultrasonic probe is used for measuring position information of an ambient object. The microprocessor controller processes the position information of the object to obtain a distance of the object and a safe avoiding direction and transmits the distance of the object and the safe avoiding direction to the prompting device. The prompting device is used for prompting the distance of the object and the safe avoiding direction.

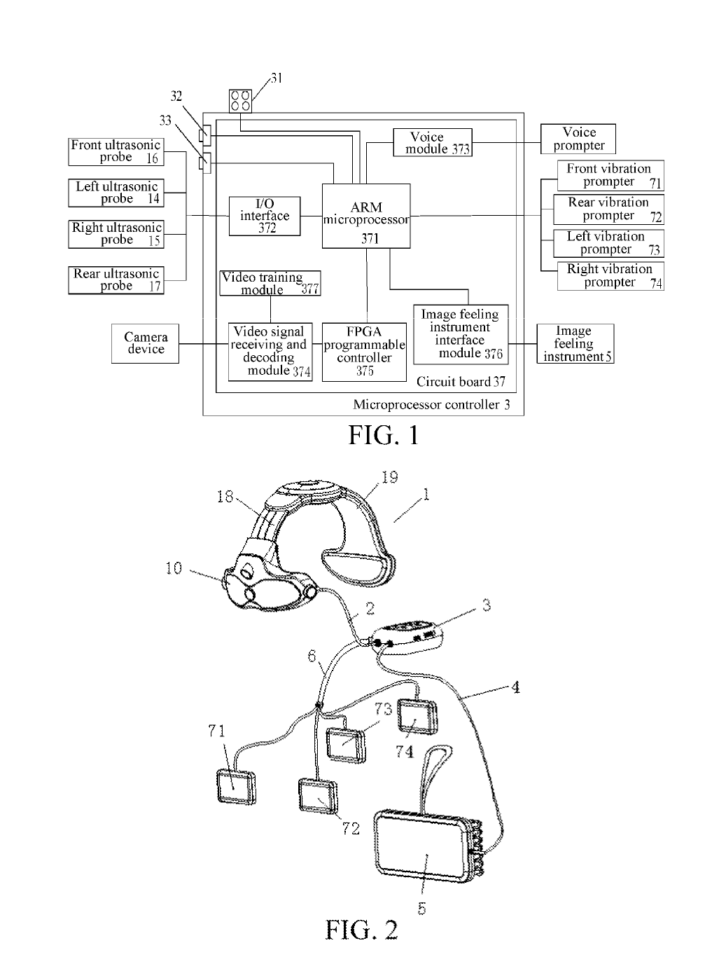

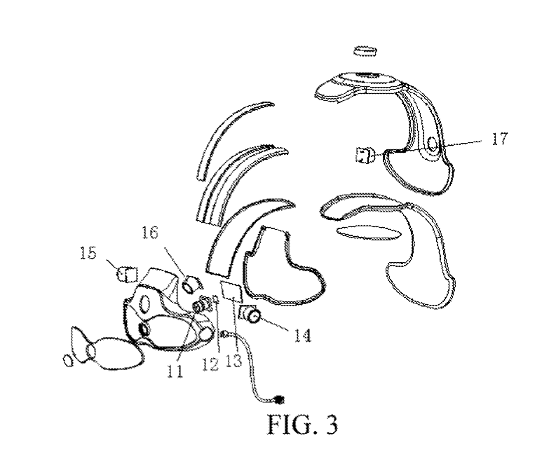

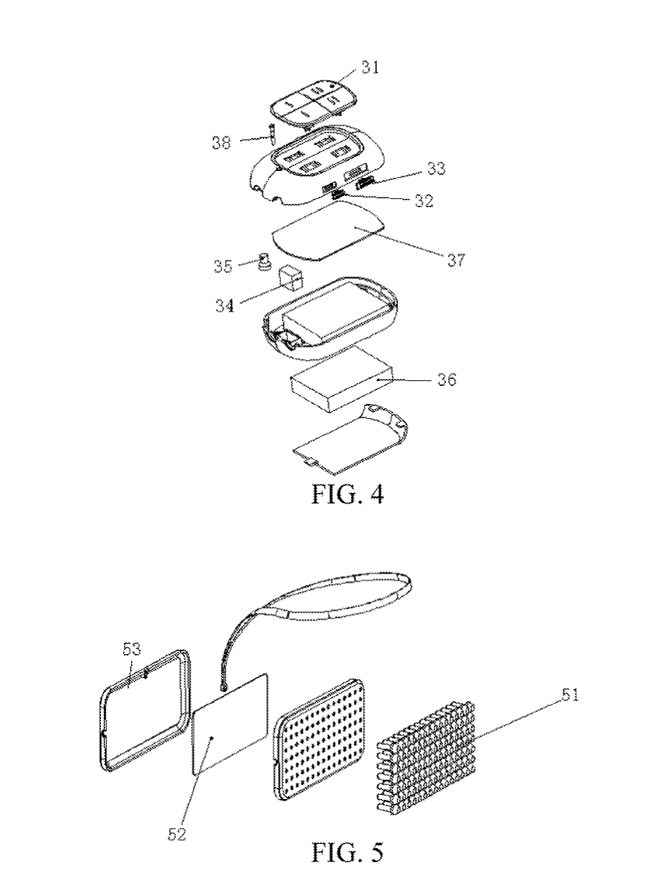

The intelligent blind-guiding device of the present application may also be called a visual blind-guider. The blind can select a certain sensitive tactile part as a “display region” with the image feeling instrument mounted therein. Specifically, as shown in FIG. 1 to FIG. 5, an intelligent blind-guiding device includes a probing mechanism 1, a microprocessor controller 3, an image feeling instrument 5, and a prompting device. The probing mechanism 1 includes a camera device and an ultrasonic probe. The microprocessor controller 3 is respectively connected to the camera device, the ultrasonic probe, the image feeling instrument 5, and the prompting device. The camera device collects a black-and-white image of front scenery. The microprocessor controller 3 performs extraction on the black-and-white image to obtain an object profile signal and converts the object profile signal into a serial signal to be output to the image feeling instrument 5. The image feeling instrument 5 converts the serial signal into a mechanical tactile signal to emit feeler pin stimulation. The ultrasonic probe is used for measuring position information of an ambient object. The microprocessor controller 3 processes the position information of the object to obtain a distance of the object and a safe avoiding direction and transmits the distance of the object and the safe avoiding direction to the prompting device. The prompting device is used for prompting the distance of the object and the safe avoiding direction.

In a preferred embodiment, the image feeling instrument 5 includes a modulation driving circuit board 52, a feeler pin array 51, and a support mechanism 53. The feeler pin array 51 and the modulation driving circuit board 52 are electrically connected with each other and are together mounted on the support mechanism 53. The feeler pin array 51 is a tactile device array formed by piezoelectric ceramic vibrators. The modulation driving circuit performs scanning, power supplying and vibrating in sequence, to form tactile excitation consistent with excitation driving of the object profile signal of the microprocessor controller 3. The processed mechanical tactile signal of the image corresponds to the feeler pin array 51 in point-to-point proportion. The feeler pin array 51 may be an independent rectangular array of mechanical vibration contacts less than 160×120, for example, two feeler pin arrays: 120×80 and 160×120. The image feeling instrument 5 outputs the mechanical tactile signal in a serial manner. An intermittent picture touch mode rather than a continuous one is used with respect to the speed of touch for vision. For example, the mechanical tactile signal is output at a tactile speed of one picture per more than one or two seconds. The support mechanism 53 is placed in a sensitive skin region of a human body, the contact is suitable for the human body sensitivity and is adaptable to be tightly fit to a sensitive tactile region of the human body such as a right-chest front region or a forehead, and it is suitable to prevent the contact from stimulating a sensitive acupuncture point.

In some embodiments, the camera device includes a camera lens 11, a black-and-white charge-coupled device (CCD) image sensor 12, and an image processing circuit 13. An object is imaged on the black-and-white CCD image sensor 12 through the camera lens 11. The image processing circuit 13 converts a black-and-white image signal scanned at a high speed into an electrical signal for processing and successively outputs analog black-and-white standard images to the microprocessor controller 3. The camera lens 11 is a manual zoom lens component of a certain view angle.

In some embodiments, the prompting device includes a voice prompter and vibration prompters 71, 72, 73, and 74. The vibration prompter can be used to prompt a distance of an object and a safe avoiding direction. The voice prompter may be used to prompt a use condition (such as switch-on/off or a working mode) of the whole blind-guiding device, where an earphone is preferably adopted, and an interface of the earphone is built in the probing mechanism 1.

In some embodiments, the microprocessor controller 3 includes a keyboard 31, a power supply 36, and a circuit board 37. An ARM microprocessor 371, an I/O interface 372, a voice module 373, a video signal receiving and decoding module 374, an FPGA programmable controller 375, and an image feeling instrument interface module 376 are disposed on the circuit board 37. The ARM microprocessor 371 is connected to the I/O interface 372, the FPGA programmable controller 375, the image feeling instrument interface module 376, the voice module 373, the power supply 36, the keyboard 31, and the vibration prompters 71, 72, 73, and 74 respectively. The FPGA programmable controller 375 is further connected to the video signal receiving and decoding module 374 and the image feeling instrument interface module 376 respectively. The video signal receiving and decoding module 374 is connected to the image processing circuit 13 of the camera device. The voice module 373 is externally connected to the voice prompter. The image feeling instrument interface module 376 is externally connected to the image feeling instrument 5. The I/O interface 372 is externally connected to the ultrasonic probes 14, 15, 16, and 17. The keyboard 31 may include four buttons (dynamic extraction/freezing, positive/negative extraction, and zoom in/out buttons).

In some embodiments, the power supply 36 is provided by a lithium battery with a large capacity built in the microprocessor controller 3. A power supply indicator lamp 38 is further disposed to prompt an electric quantity. Moreover, the microprocessor controller 3 further includes a function changing-over switch 33, a power supply switch 32, a loudspeaker 35, and a buzzer 34. The function changing-over switch 33 is connected to the ARM microprocessor 371 and has a training option and a normal option. The circuit board 37 further includes a video training module 377, connected to the video signal receiving and decoding module 374. An operating system in the ARM microprocessor 371 is the LINUX embedded operating system, and software in the ARM microprocessor 371 includes ultrasonic measurement management software, safe avoiding software, and video training and learning software. The FPGA programmable controller 375 performs image conversion processing on an image collected by the video signal receiving and decoding module 374 to obtain an object profile signal, performs a proportion corresponding operation on the processed image profile signal, and outputs the signal to the image feeling instrument interface module 376 to generate a serial output required by the image feeling instrument, wherein the image conversion processing includes image freezing, dynamic capturing, image zoom-in, image zoom-out, positive strengthening, and negative strengthening.

The video training module 377 may include the following information: 1) common objects: a photo image, a profile image, a three-dimensional static profile, and a three-dimensional rolling profile; a distance-transformed mobile profile image; 2) daily mobile object: a photo image, a profile image, a three-dimensional static profile, and a three-dimensional rolling profile; a distance-transformed mobile profile image; and a movement image; 3) persons and animals: a photo image, a profile image, a three-dimensional static profile, and a three-dimensional rolling profile; a distance-transformed mobile profile image; and a movement image; 4) dangerous objects: a photo image, a profile image, a three-dimensional static profile, and three-dimensional rolling profile; a distance-transformed mobile profile image; and 5) environmental organisms: a photo image, a profile image, a three-dimensional static profile, and three-dimensional rolling profile; a distance-transformed mobile profile image. Meanwhile, the corresponding object model is perceived through a hand, or after the camera shoots an image, through the comparison of the image feeling instrument, training and learning are performed to obtain and improve the capability of identifying the shape of an object. In this way, the blind can see increasingly more objects through learning.

In some embodiments, the probing mechanism 1 may be a head mechanism, including an adjustable head band 18, a glass body 10, and a fixing mechanism 19. The glass body 10 is connected to the fixing mechanism 19 through the head band 18. Four ultrasonic probes are provided and include front, rear, left, and right ultrasonic probes. Each ultrasonic probe includes a transmission probe and a receiving probe. The camera lens 11 of the camera device and the front ultrasonic probe 16 are mounted right in front of the glass body 10. The left ultrasonic probe 14 and the right ultrasonic probe 15 are respectively mounted on left and right sides of the glass body 10. The rear ultrasonic probe 17 is mounted in the fixing mechanism 19. Each ultrasonic probe probes position information of an object in the corresponding direction thereof. The transmission probe and the receiving probe are respectively connected to the microprocessor controller 3 and are respectively used for receiving a scan signal of the microprocessor controller 3 and receiving an ultrasonic signal and sending the ultrasonic signal to the microprocessor controller 3. The microprocessor controller 3 uses a specific bionic algorithm to obtain a safe avoiding direction according to the position information of the object probed by the ultrasonic probe. The vibration prompters include front, rear, left, and right vibration prompters, which prompt the position of the object and the safe avoiding direction according to the object direction probed by the front, rear, left, and right ultrasonic probes. The microprocessor controller 3 is connected to the probing mechanism 1 through a cable 2, is connected to the image feeling instrument 5 through a cable 4, and is connected to the four vibration prompters respectively through a cable 6. When being worn, the glass body 10 is placed in front of human eyes, which equals that a pair of glasses is worn. The head band 18 is placed on the top of the head and can be adjusted according to the features of the head shape of the human body to ensure comfortable wearing. The fixing mechanism 19 is placed at the back of the head. A protection pad is further disposed at a side of the probing mechanism 1 contacting the human body so that the contacted skin is more comfortable. The microprocessor controller 3 may be fixed in a belt bag. When being worn, the vibration prompter can be worn on the chest/back or the left/right hand of the human body by a removable adhesive tape. The image feeling instrument may be worn on the front chest or the back according to the individual features of the blind.

A specific operation of an intelligent blind-guiding device of a preferred embodiment is as follows:

The power supply switch 32 of the microprocessor controller 3 is switched to an on position, and the intelligent blind-guiding device begins to work. Since the function changing-over switch 33 may have the training option and the normal option, when the function changing-over switch 33 is switched to the training option, the microprocessor controller 3 cuts off the power supply of the image processing circuit 13 in the probing mechanism 1, the camera lens 11 does not work, the video training module 377 in the microprocessor controller 3 begins to work to generate an image signal used for emulation of a control circuit of the blind-guiding device, and meanwhile the microprocessor controller 3 drives the peripheral components to work as follows.

The four ultrasonic probes 14, 15, 16, and 17 embedded in the probing mechanism 1 receives a measurement starting instruction from the microprocessor controller 3 through the cable 2. In order to avoid signal interference between multiple ultrasonic probes, the four ultrasonic probes are started in turn. The front ultrasonic probe 16, the right ultrasonic probe 15, the left ultrasonic probe 14, the rear ultrasonic probe 17 and the relevant accessory circuits may be started successively (definitely, the order is not limited thereto). An obtained measurement result is sent back to the microprocessor controller 3 through the cable 2.

The microprocessor controller 3 receives position distance signals from the ultrasonic probes 16, 15, 14, and 17 of the probing mechanism 1 in turn. The ARM microprocessor 371 takes a position distance of an object in a corresponding direction respectively, calculates vibration amplitude according to the position distance of the object, performs a barrier avoiding competition algorithm on the data in the four directions to judge a safe direction, and sends the safe direction to the vibration prompters 7, 8, 9, and 10 through the control cable 6.

The microprocessor controller 3 controls, according to an instruction of the keyboard 31, the video signal receiving and decoding module 374 to receive an image signal played by the video training module 377, and sends the image signal to the FPGA programmable controller 375 for image conversion processing. The image conversion processing includes image freezing, dynamic capturing, image zoom-in, image zoom-out, positive strengthening, and negative strengthening (according to the requirement on the image, a combination of one or more processing manners may be adopted to obtain a signal capable of being recognized by the blind). The processed image information is converted into 160×120 or 120×80 image information through scale conversion. The image feeling instrument interface module 376 generates a serial output signal required by the image feeling instrument 5 and sends the serial output signal to the image feeling instrument 5 through the cable 4.

A control circuit of the modulation driving circuit board 52 in the image feeling instrument 5 receives a serial image signal, a clock signal, a field sequential signal and so on from the microprocessor controller 3, shifts the signals to corresponding internal row, field array registers respectively in order, modulates the signals into a piezoelectric ceramic body driving frequency, generates vibration information of corresponding contact positions, and sends the vibration information to the feeler pin array 51, so that feeler pins corresponding to the image vibrate.

When the function changing-over switch 33 of the microprocessor controller 3 is switched to the normal option, the video training module 377 in the microprocessor controller 3 stops working, the microprocessor controller 3 sends the power supply to the probing mechanism 1 through the cable 2, and the camera lens 11, the black-and-white CCD image sensor 12, the image processing circuit 13 in the probing mechanism 1 begin to work. External scenery is imaged on the black-and-white CCD image sensor 12 through the camera lens 11. The image processing circuit 13 processes image information obtained by the black-and-white CCD image sensor 12 and successively outputs analog black-and-white standard image signals CVBS, and sends the analog black-and-white standard image signals to the microprocessor controller 3 through the cable 2.

The microprocessor controller 3 controls, according to an instruction of the keyboard 31, the video signal receiving and decoding module 374 to receive an image signal from the camera device, and sends the image signal to the FPGA programmable controller 375 for image conversion processing. The image conversion processing includes image freezing, dynamic capturing, image zoom-in, image zoom-out, positive strengthening, and negative strengthening (according to the requirement on the image, a combination of one or more processing manners may be adopted to obtain a signal capable of being recognized by the blind). The processed image information is converted into 160×120 or 120×80 image information through scale conversion. The image feeling instrument interface module 376 generates a serial output signal required by the image feeling instrument 5 and sends the serial output signal to the image feeling instrument 5 through the cable 4.

A control circuit of the modulation driving circuit board 52 in the image feeling instrument 5 receives the image signal, a clock signal, a field sequential signal and so on from the microprocessor controller 3, shifts the signals to corresponding internal row, field array registers respectively in order, modulates the signals into the piezoelectric ceramic body driving frequency, generates vibration information of the corresponding contact positions, and sends the vibration information to the feeler pin array 51, so that feeler pins corresponding to the image vibrate.

Meanwhile, the four ultrasonic probes 14, 15, 16, and 17 embedded in the probing mechanism 1 receive a measurement starting instruction from the microprocessor controller 3 through the cable 2. In order to avoid signal interference between multiple ultrasonic probes, the front ultrasonic probe 16, the right ultrasonic probe 15, the left ultrasonic probe 14, the rear ultrasonic probe 17 and the relevant accessory circuits are started in order, and an obtained measurement result is sent back to the microprocessor controller 3 through the cable 2. The microprocessor controller 3 receives position distance signals from the ultrasonic probes 16, 15, 14, and 17 of the probing mechanism 1 in turn. The ARM microprocessor 371 takes a position distance of a barrier in a corresponding direction respectively, calculates vibration amplitude according to the position distance of the barrier, performs a new-fish barrier avoiding heuristic algorithm on the data in the four directions to judge a safe direction, and sends the safe direction to the vibration prompters 7, 8, 9, and 10 through the control cable 6.

A black-and-white camera is used to collect an image of front scenery, image conversion processing is performed on the obtained image to generate main profile information, and the image feeling instrument converts the image signal into the mechanical tactile signal, so that a third “sense for vision region” of a human body or biological sense “artificial eyes” are generated, so that the blind can “see” the shape of an object. A series of training and learning is performed, and through gradual accumulation, more object targets are “seen”, so as to improve the capability of the “artificial eyes” identifying the shape of the object or improve the eyesight level of “artificial eyes”, so that the blind may feel more object shapes. Meanwhile, the ultrasonic probes mounted in multiple directions can scan an ambient barrier to acquire position information of the ambient barrier, and the bionic algorithms of two modes, a competition mode in the case of congestion and a normal state, are adopted to prompt the safe avoiding direction for the barrier, being further capable of helping the blind to enhance the capability of recognizing the surrounding object or even the capability of watching a figure or reading a character, thereby resulting in more effective blind-guiding assistance.

Through the assistance of the device, the blind can not only effectively probe the surrounding barrier, but also avoid the surrounding barrier object, “see” the profile of the object in front of eyes through the camera lens, recognize the shape of the object, and through continuous training and accumulation, know increasingly more objects gradually.

The foregoing content is detailed description of the present application with reference to the specific preferred embodiments, but it cannot be considered that the specific implementation of the present application is limited to the description. Several equal replacements or obvious variations with the same performance and usage made by persons of ordinary skill in the art without departing from the idea of the present application all should be construed as falling within the protection scope of the present application.

1. A visual blind-guiding method, comprising:
(1) shooting a black-and-white image, and extracting profile information from the black-and-white image to reduce detail elements and refine the image, so as to obtain an object profile signal;
(2) according to ergonomic features, converting the object profile signal into a serial signal, conveying the serial signal to an image feeling instrument, wherein the image feeling instrument converts the serial signal into a mechanical tactile signal to emit feeler pin stimulation, an intermittent picture touch mode is used with respect to the speed of touch for vision, and an appropriate human body-sensitive feeler pin array is adopted with respect to the quantity, so that the blind really touch a shape of an object.

2. The visual blind-guiding method according to claim 1, further comprising a step (3): probing position information of the object, and processing the position information to obtain and prompt a distance of the object and a safe avoiding direction.

3. The visual blind-guiding method according to claim 1, wherein the feeler pin array is a rectangular array of mechanical vibration contacts.

4. An intelligent blind-guiding device, comprising a probing mechanism, a microprocessor controller, an image feeling instrument, and a prompting device, wherein the probing mechanism comprises a camera device and an ultrasonic probe, the microprocessor controller is respectively connected to the camera device, the ultrasonic probe, the image feeling instrument, and the prompting device, the camera device is used for collecting a black-and-white image of front scenery, the microprocessor controller performs extraction on the black-and-white image to obtain an object profile signal, converts the object profile signal into a serial signal, and outputs the serial signal to the image feeling instrument; the image feeling instrument converts the serial signal into a mechanical tactile signal to emit feeler pin stimulation, the ultrasonic probe is used for measuring position information of an ambient object, the microprocessor controller processes the position information of the object to obtain a distance of the object and a safe avoiding direction and transmits the distance of the object and the safe avoiding direction to the prompting device; and the prompting device is used for prompting the distance of the object and the safe avoiding direction.

5. The intelligent blind-guiding device according to claim 4, wherein the image feeling instrument comprises a modulation driving circuit board, a feeler pin array and a support mechanism for mounting the modulation driving circuit board and the feeler pin array, the modulation driving circuit board is used for receiving, in series, the serial signal sent by the microprocessor controller and driving, in series, the feeler pin array to work, and the object profile signal corresponds to the feeler pin array in a point-to-point proportion.

6. The intelligent blind-guiding device according to claim 4, wherein the feeler pin array is a rectangular array of mechanical vibration contacts formed by piezoelectric ceramic vibrators, and the support mechanism is tightly fit to a sensitive skin region of a human body.

7. The intelligent blind-guiding device according to claim 4, wherein the microprocessor controller comprises a keyboard, a power supply, and a circuit board; an ARM microprocessor, an input/output (I/O) interface, a voice module, a video signal receiving and decoding module, a Field Programmable Gate Array (FPGA) programmable controller, and an image feeling instrument interface module are disposed on the circuit board; the ARM microprocessor is connected to the I/O interface, the FPGA programmable controller, the image feeling instrument interface module, the voice module, the power supply, the keyboard, and vibration prompters; the FPGA programmable controller is connected to the video signal receiving and decoding module; the video signal receiving and decoding module is connected to the camera device; the voice module is externally connected to a voice prompter; the image feeling instrument interface module is externally connected to the image feeling instrument; and the I/O interface is externally connected to the ultrasonic probes.

8. The intelligent blind-guiding device according to claim 7, wherein the microprocessor controller further comprises a function changing-over switch, the function changing-over switch is connected to the ARM microprocessor and comprises a training option and a normal option, the circuit board further comprises a video training module, and the video training module is connected to the video signal receiving and decoding module.

9. The intelligent blind-guiding device according to claim 7, wherein the FPGA programmable controller is used for performing image conversion processing on an image collected by the video signal receiving and decoding module to obtain the object profile signal, and the image conversion processing comprises image freezing, dynamic capturing, image zoom-in, image zoom-out, positive strengthening, or negative strengthening.

10. The intelligent blind-guiding device according to claim 4, wherein the probing mechanism is a head mechanism, which comprises an adjustable head band, a glass body, and a fixing mechanism; the glass body is connected to the fixing mechanism through the head band; four ultrasonic probes are provided and comprise front, rear, left, and right ultrasonic probes, and each ultrasonic probe comprises a transmission probe and a receiving probe; a camera lens of the camera device and the front ultrasonic probe are mounted right in front of the glass body; the left ultrasonic probe and the right ultrasonic probe are respectively mounted at left and right sides of the glass body; the rear ultrasonic probe is mounted in the fixing mechanism; the prompting device comprises front, rear, left, and right vibration prompters, respectively used for prompting the distance of the object and the safe avoiding direction according to the direction of the object probed by the front, rear, left, and right ultrasonic probes.

11. The intelligent blind-guiding device according to claim 5, wherein the probing mechanism is a head mechanism, which comprises an adjustable head band, a glass body, and a fixing mechanism; the glass body is connected to the fixing mechanism through the head band; four ultrasonic probes are provided and comprise front, rear, left, and right ultrasonic probes, and each ultrasonic probe comprises a transmission probe and a receiving probe; a camera lens of the camera device and the front ultrasonic probe are mounted right in front of the glass body; the left ultrasonic probe and the right ultrasonic probe are respectively mounted at left and right sides of the glass body; the rear ultrasonic probe is mounted in the fixing mechanism; the prompting device comprises front, rear, left, and right vibration prompters, respectively used for prompting the distance of the object and the safe avoiding direction according to the direction of the object probed by the front, rear, left, and right ultrasonic probes.

12. The intelligent blind-guiding device according to claim 6, wherein the probing mechanism is a head mechanism, which comprises an adjustable head band, a glass body, and a fixing mechanism; the glass body is connected to the fixing mechanism through the head band; four ultrasonic probes are provided and comprise front, rear, left, and right ultrasonic probes, and each ultrasonic probe comprises a transmission probe and a receiving probe; a camera lens of the camera device and the front ultrasonic probe are mounted right in front of the glass body; the left ultrasonic probe and the right ultrasonic probe are respectively mounted at left and right sides of the glass body; the rear ultrasonic probe is mounted in the fixing mechanism; the prompting device comprises front, rear, left, and right vibration prompters, respectively used for prompting the distance of the object and the safe avoiding direction according to the direction of the object probed by the front, rear, left, and right ultrasonic probes.

13. The intelligent blind-guiding device according to claim 7, wherein the probing mechanism is a head mechanism, which comprises an adjustable head band, a glass body, and a fixing mechanism; the glass body is connected to the fixing mechanism through the head band; four ultrasonic probes are provided and comprise front, rear, left, and right ultrasonic probes, and each ultrasonic probe comprises a transmission probe and a receiving probe; a camera lens of the camera device and the front ultrasonic probe are mounted right in front of the glass body; the left ultrasonic probe and the right ultrasonic probe are respectively mounted at left and right sides of the glass body; the rear ultrasonic probe is mounted in the fixing mechanism; the prompting device comprises front, rear, left, and right vibration prompters, respectively used for prompting the distance of the object and the safe avoiding direction according to the direction of the object probed by the front, rear, left, and right ultrasonic probes.

14. The intelligent blind-guiding device according to claim 8, wherein the probing mechanism is a head mechanism, which comprises an adjustable head band, a glass body, and a fixing mechanism; the glass body is connected to the fixing mechanism through the head band; four ultrasonic probes are provided and comprise front, rear, left, and right ultrasonic probes, and each ultrasonic probe comprises a transmission probe and a receiving probe; a camera lens of the camera device and the front ultrasonic probe are mounted right in front of the glass body; the left ultrasonic probe and the right ultrasonic probe are respectively mounted at left and right sides of the glass body; the rear ultrasonic probe is mounted in the fixing mechanism; the prompting device comprises front, rear, left, and right vibration prompters, respectively used for prompting the distance of the object and the safe avoiding direction according to the direction of the object probed by the front, rear, left, and right ultrasonic probes.

15. The intelligent blind-guiding device according to claim 9, wherein the probing mechanism is a head mechanism, which comprises an adjustable head band, a glass body, and a fixing mechanism; the glass body is connected to the fixing mechanism through the head band; four ultrasonic probes are provided and comprise front, rear, left, and right ultrasonic probes, and each ultrasonic probe comprises a transmission probe and a receiving probe; a camera lens of the camera device and the front ultrasonic probe are mounted right in front of the glass body; the left ultrasonic probe and the right ultrasonic probe are respectively mounted at left and right sides of the glass body; the rear ultrasonic probe is mounted in the fixing mechanism; the prompting device comprises front, rear, left, and right vibration prompters, respectively used for prompting the distance of the object and the safe avoiding direction according to the direction of the object probed by the front, rear, left, and right ultrasonic probes.
